(19) United States
(12) Patent Application Publication
(10) Pub. No.: US 2005/0010697 A1
(43) Pub. Date: Jan. 13, 2005

(54) System for bandwidth detection and content switching

(76) Inventors: Husam Kinawi, Calgary (CA); Hongwen Zhang, Calgary (CA)

Correspondence Address: MCNAIR LAW FIRM, PA, P.O. BOX 10827, GREENVILLE, SC, 29603-0827, US

(21) Appl. No.: 10/748,430

(22) Filed: Dec. 30, 2003

Related U.S. Application Data
(60) Provisional application No. 60/437,083, filed on Dec. 30, 2002.

(51) Int. Cl. G06F 3/00

(52) U.S. Cl. 710/1

(57) ABSTRACT

This invention is a system and corresponding method having a computer readable medium, a set of content in communications with said computer readable medium containing content for at least one bandwidth, and a set of computer readable instructions embodied in said computer readable medium for receiving a content request from said output device, generating at least one detection packet for transmission to said output device, receiving at least one detection packet return from said output device, determining the bandwidth of said output device according to said at least one detection packet and said at least one detection packet return, retrieving content from said set of content, according to the bandwidth of said output device, and for transmission to said output device so that said output device can receive and display content compatible with the bandwidth of said output device, and formatting said content according to the bandwidth of said output device.

### CROSS-REFERENCE TO RELATED APPLICATION

This application claims priority on provisional patent application Ser. No. 60/437,083, entitled System for Bandwidth Detection and Content Switching, filed Dec. 30, 2002, and incorporated herein by reference.

### FIELD OF THE INVENTION

This invention is directed to a computerized system and method for providing content to an output device, and more specifically, a system for tailoring or customizing content to an output device according to the specific content being sent and the capabilities, particularly bandwidth, of the specific output device.

### BACKGROUND OF THE INVENTION

From mid-1980 to the present there has been an extraordinary adaptation of computers and more specifically, the Internet, in almost all aspects of business and personal life. To use the Internet, however, an output device is required for viewing content. Such devices include Palm Pilots, cellular telephones, laptop computers, personal digital assistances, thin clients, and desktop computers. The development of these devices have led to an unprecedented use of the Internet around the world. As output devices that connect to the Internet become faster and faster, Internet content providers are providing more and more complex and multimedia based content. Since information is most effectively conveyed visually, the content provided to users includes movies, audio, digital images, slide shows, and other usual content. While these types of content are a great benefit for desktop users with fast connections, such content is a burden on those with Palm Pilots and desktops which generally have less capacity to display such multimedia content. These users of lower capacity devices and connections must endure lengthy downloads of content, particularly of images and multimedia features included in complex content. Content providers are then faced with the decision of which users they must disappoint when deciding to provide complex content or not. If the content providers provide content that is high in multimedia content, users with low bandwidth devices cannot benefit from such content. These users must wait an inordinately long time to receive this complex content. On the other hand, if the content provider shifts to more of a text-only format for their content, then the users with high bandwidth will be disappointed because they do not receive the most informative content that their devices can support. Thus, it would be advantageous for a content provider to know the bandwidth by which a device can receive information prior to sending content so that the content can be formatted accordingly.

Previous attempts to provide for bandwidth detection by the content provider have not provided a satisfactory remedy. Previous attempts fall short in that they do not allow for unilateral bandwidth detection by the content provider nor provide for specific content for specific devices.

For example, U.S. Pat. No. 6,345,279 discloses “transcoding” multimedia content into a plurality of “transcoded content versions” so that each version has different modalities and resolutions. The particular transcoded version of the multimedia content is selected to be transmitted to the client device so as to logically display the content specific to the device's ability to present the content. Principally, this reference discloses the capabilities of a client device to display multimedia content specific to the particular device. For example, a video item can be transcoded into a select set of images so that the images are displayed on devices that are not capable of displaying the actual video itself. The resources of the client devices are allocated among the items with the content to be displayed so that if a client has limited resources, some of the content items may not get any resources and not deliver to the client while others are transcoded to two smaller pieces of information. The content is dynamically adapted to the client device and also allows the content author to control the adaptation process. However, the client device in this reference is characterized by a client profile that represents the capabilities and resources of the client device. This reference does not allow the content provider to unilaterally detect the bandwidth of the receiving device and provide the appropriate content to the client device accordingly. Additionally, this reference is limited in that it requires that content be altered from its native format such as from still images to video.

Another example at an attempt for content modification is patent application Publication No. 2002/0033844. This reference discloses a method of connecting multimedia content to a network resource operating in a network environment. An identifier is extracted from a media signal that identifies the device type. Data transmitted to the device is adapted according to the device type information. The device type information can also include a connection speed so that data can be optimized for the connection speed of the device. However, this reference does not allow content providers to unilaterally detect the bandwidth of the receiving device and alter the content transmitted to the client device accordingly.

Another example of an attempt for content modification is patent application Publication No. 2002/0040386. This reference, however, is limited in that it requires the characteristics of the “accessing device” to be transmitted to the content provider through an access request. An adaptation step adapts the content of a document from an information server according to the characteristics of the requesting device. However, the acquisition of characteristics from the requesting device is done by analyzing the access request from the device rather than by the content provider unilaterally determining the bandwidth of the device.

Another example of an attempt to modify content is patent application Publication No. 2001/0052077. This reference is directed to a method for allowing client devices with different characteristics to receive custom content from servers. Again, this reference is limited because each client has an associated “universal mobile ID” that designates the client's characteristics as well as the user's preferences. Based upon the universal mobile ID, content can be formatted for that particular client at the server.

None of the above references allow the content provider to unilaterally detect the bandwidth of the receiving device and alter the content transmitted to the client device accordingly. Accordingly, an object of the present invention is to provide a system for a content provider to unilaterally detect the bandwidth capabilities of a device and provide content based on the bandwidth capabilities.

### SUMMARY OF THE INVENTION

The above objectives are accomplished according to the present invention by providing a system and method for determining the bandwidth of the receiving device by first having computer readable instructions send a packet of data to the output device. The data packet has information that is not recognized by the output device causing the output device to send the packet back to the content provider server. The computer readable instructions of the content provider determines the amount of time from when the unrecognized data packet is sent to the output device and a message is returned from the output device saying that the data packet is unrecognized. By knowing the time it takes the packet to go from the server to the output device and back, the bandwidth of the output device can be calculated. Based upon the calculated bandwidth, the type of content adequate for the bandwidth of the output device is selected. The content is retrieved from memory by the content provider then sent to the receiving output device.

This functionality is achieved by providing a system and method utilizing a computer readable medium, a set of content in communications with the computer readable medium containing content for at least one bandwidth, and a set of computer readable instructions embodied in the computer readable medium for receiving a content request from the output device, generating at least one detection packet for transmission to the output device, receiving at least one detection packet return from the output device, determining the bandwidth of the output device according to the at least one detection packet and the at least one detection packet return, retrieving content from the set of content, according to the bandwidth of the output device, and for transmission to the output device so that the output device can receive and display content compatible with the bandwidth of the output device. Further, this invention can have computer readable instructions for formatting the content according to the bandwidth of the output device and the set of content can contain a plurality of content versions associated with predetermined bandwidths. The invention can further have the set of content contains content for at least one output device and the content request can include a device ID so that the set of computer readable instructions includes instructions for retrieving content from the set of content according to the bandwidth of the output device and the device ID. The invention can be embodied where the content request includes location information representing the geographic location of the output device; and, the computer readable instructions include instructions for retrieving content from the set of content according to the location information. In addition to a single set of content, the invention can include a plurality of sets of content so that responsive to the content request including content set information, the computer readable instructions can include instructions for retrieving content from at least one set of content according to the content set information.

This invention also includes a method for providing content to an output device comprising the steps of receiving a content request from the output device, determining the bandwidth of the output device according to a detection packet and a detection packet return; and, providing content to the output device according to the bandwidth of the output device. This method can include the steps of formatting the content according to the bandwidth of the output device, receiving location information representing the location of the output device; and, providing content to the output device according to the location information.

In another embodiment, the invention is a system for providing content to output devices comprising a computer readable medium, a set of content in communication with the computer readable medium and associated with device IDs or device types having content for at least one device ID, the device ID representing bandwidth capacity for at least one output device, and a set of computer readable instructions for receiving a content request having device ID information representing bandwidth capabilities of the output device, determining if the received device ID is associated with content in the set of content, retrieving content according to the device ID from the set of content if the received device ID is associated with content, generating at least one detection packet for transmission to the output device if the received device ID is not associated with content, receiving at least one detection packet return according to the transmitted detection packet, determining the bandwidth of the output device according to the detection packet and the detection packet return, retrieving content from the set of content according to the bandwidth, and transmitting the content to the output device.

The invention can include instructions for formatting the content according to the device ID, formatting the content according to the bandwidth of the output device, instructions for retrieving content from the set of content according to the location information of the content request.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of the invention;

FIG. 2 is a flowchart illustrating the invention; and,

FIG. 3 is a schematic detailing the invention.

### DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. A computer readable medium can contain computer readable instructions that are actual computer or executable code. This code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer readable instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

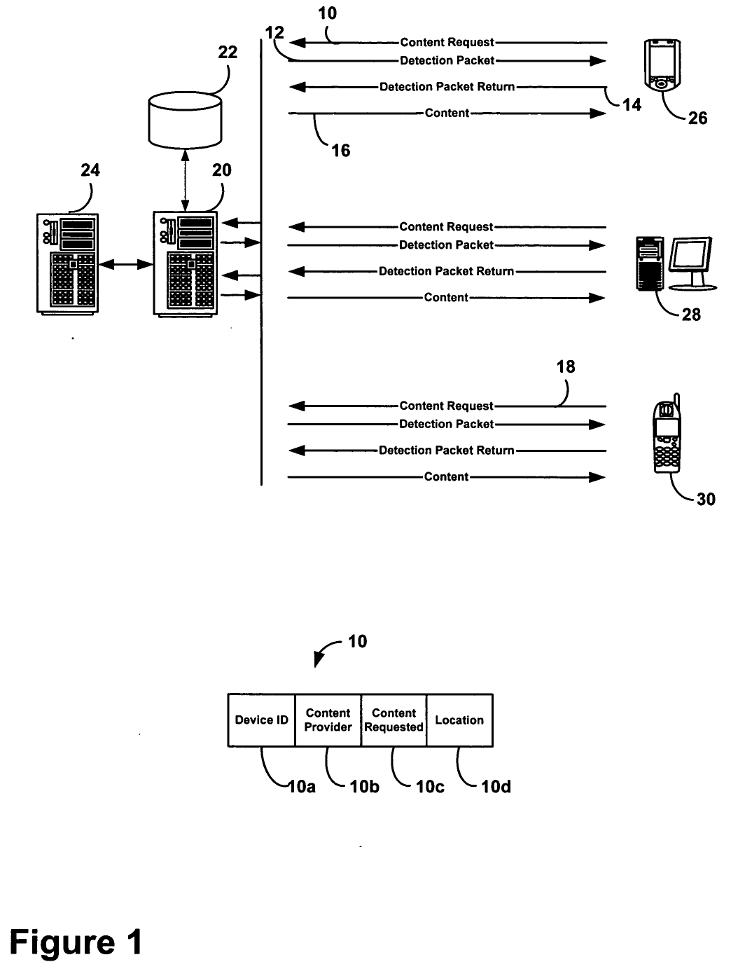

Referring now to FIG. 1, the invention is described in more detail. The process is initiated by a requesting output device, such as a personal digital assistant (PDA) 26, personal computer (PC) 28, or cellular phone 30 that requests content from a content provider 24. A content request 10 is transmitted from output device such as device 26, 28, or 30, to an access provider 20. It should be noted that access provider 20 and content server 24 need not be separate computer or server systems, but can be contained in a single or multiple computers or servers. A set of content 22 is in communication with access provider 20, but can reside on content provider 24, access provider 20 or other location in communication with access provider 20. The content request can also contain the device ID or device type as shown by 10a of content request 10. The device ID identifies the type of device requesting content. For example, the device ID may represent to the invention that the output device is a PDA or perhaps a cellular phone. The content request can also contain content provider identification 10b that contains information concerning the source of the content, a content request 10c identifying the specific content requested from content provider 24. Location information can be in content request 10 and can include the geographic location of the output device so that that the access provider can determine the location of the output device. Having location information allows the content or access provider to retrieve geographic specific or location based content and provides it to the output device. For example, time and weather associated with the geographic location of the output device. Further, coupon information can be sent to the device if the output device happens to be located in a particular store, vendor, or other product or service provider. The language of the content can also be translated or formatted based upon the geographic location of the output device. For example, the language of the content can be translated to French for Quebec, Canada, but kept in English for the United States.

When the access provider receives the content request, the access provider sends a detection packet 12 to the output device. The detection packet contains information that requires the receiving output device to return information. Therefore, the receiving device sends a detection packet return 14 to the content provider. The content provider then determines the bandwidth capacity of the receiving output device by measuring the time between the sending of the detection packet and receiving the detection packet return. The time between sending the detection packet and receiving the detection packet return can be further explained by using HTML and JavaScript terminology. When the output device transmits a content request, the computer readable instructions build the largest cookie that it can, currently a four kilobytes cookie, and associates a time with the cookie. The output device is then redirected to the page that it requested so as to initialize the cookie. The output device is then redirected to the same page. The time elapsed between the sending and receiving of information is used to determine the bandwidth of the output device. In the preferred embodiment, the send and receive transmissions are performed at least twice and an average of the time elapsed is used to determine the bandwidth. Clearly, the longer the time elapsed, the lower the bandwidth of the output device and the less capable the output device is to receive complex or high-definition content. For a high bandwidth output device, the access provider can send more information to the output device. For low bandwidth output devices, the access provider sends less information to the output device. The access provider can act as a translator, filter, and interpreter for content sent from the content provider to the output device. Based upon the bandwidth, device ID or type, physical location or content requested, the content provider or access provider can perform the selection of content, translation of content, filtration of content or interpretation of content for the output device. For high bandwidth devices, such as personal computer 28 on a high-speed network, the access provider will allow complete audio and video to be sent to the output device. For low bandwidth devices, such as cellular phone 30, the access provider may prevent audio and video to be sent to the output device.

For low bandwidth or other output devices, there may be limitations concerning the transmission rate in which the output device can receive information. Therefore, it may be advantageous to regulate or otherwise control the data transmission speed of content provided to the output device. Once the content is retrieved, the content can be stored in a buffer or cache and transmitted to the output device in a regulated manner. The invention can then stream the content to the output device with a regulated transmission rate compatible with the device type and the device's bandwidth.

Content can be stored as a set of content. There can be several versions of the same content such as a high bandwidth version and a low bandwidth version. Therefore, the appropriate content can be retrieved based upon the bandwidth capacity of the output device or the device ID or type. Alternatively, content can be stored without respective bandwidth versions, but can be retrieved and subsequently formatted according to the bandwidth of the output device. In both cases, the set of content can be stored in computer readable storage in communication with the computer readable medium of this invention.

If the output device sends a device ID 10a to the access provider, the access provider can retrieve content from a set of content 22 that correspond to different device ID's and represent display criteria of the output device. Display criteria can include the ability of the output device to output audio, video, color, high-resolution, different languages, HTML or XML, or other such factors for determining what an output device can display. If the device ID corresponds to a PDA, the invention may determine not to send high-definition audio and video files to the output device. However, if the device ID corresponds to a desktop computer, the invention may send high-definition information.

As noted, the content request can also contain content set information. Referring to FIG. 1, content may be contained in computer readable storage of location 20 or 24. Physically, location 20 and 24 can be miles and even countries apart. Therefore, output devices can request content from a specific content provider having a set of content and include such request in the content request. As such, the request content is retrieved from the requested set of content and its location.

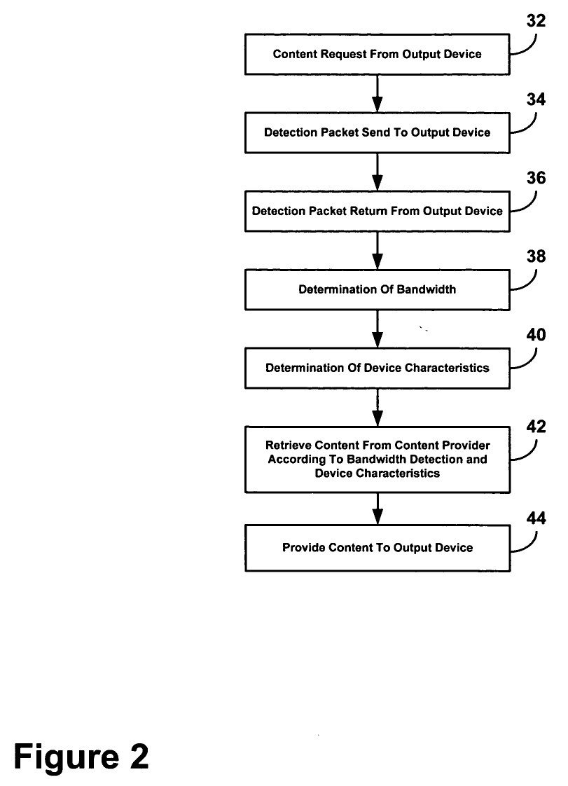

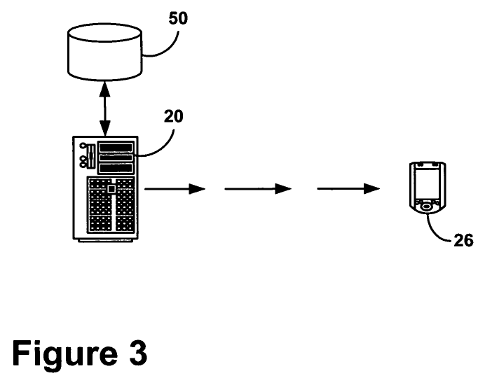

Referring now to FIG. 2, the method of practicing this invention is described in more detail. The output device transmits a content request access provider in step 32. The access provider then transmits a detection packet to the output device in step 34. The detection packet return is then transmitted from the output device to access provider in step 36 in response to the detection packet. The access provider can then make a determination of the bandwidth of the output device by measuring the time it takes between the transmission of the detection packet to the receipt of the detection packet return from the output device. It should be noted that steps 34 and 36 can be repeated as needed in order to provide a sufficient number of sends and receives in order to make a determination of the bandwidth of the output device. By having multiple sets of sends and receives, an average of the time can be used for bandwidth determination. Additionally, the content request can contain a device ID so that the access provider can determine the device type of the output device in step 40. Once the access provider knows the bandwidth of the output device, the device type, or both, then the access provider can request content from the content provider according to the bandwidth of the device in step 42. After the content is retrieved from the content provider, the content may be formatted or translated for the output device according to the bandwidth of the output device or device type in step 44. In the event that the content request from the output device contains location information, location based content can be provided to the output device in step 46. In the event that the bandwidth of the output device requires the content to be buffered or streamed to the output device, the content can be buffered for transmission in step 48. In the event that the output device is only able to receive content at a certain speed or throughput, the content can be buffered or cached and the transmission of the content to the output device can be flow controlled so as to prevent the content from being transmitted too rapidly for the capacity or bandwidth of the output device. In FIG. 3, the computer readable medium can store the retrieved content in the buffer 50. The content can then be streamed or flow-controlled to output device 26 so as to prevent the overrun of information at the output device. This retrieved content is then formatted and transmitted to the output device in step 50 (FIG. 2) so that the output device receives content that is compatible with the bandwidth and device characteristics of the output device.

In another embodiment, the functionality herein described can be performed by computer readable instructions of the content provider rather than the access provider. When the output device sends content request 10, the content request is received by content provider 24. The content provider then generates a detection packet to the output device to be sent to the output device. When the output device receives the detection packet, the output device sends a detection packet return 14 back to the content provider. The content provider determines the amount of time between generating the detection packet for sending to the output device and the receipt of the detection packet return. Accordingly, the bandwidth that the output device is capable of receiving is determined and content is retrieved or formatted according to the content request and bandwidth determined.

While a preferred embodiment of the invention has been described using specific terms, such description is for illustrative purposes only, and it is to be understood that changes and variations may be made without departing from the spirit or scope of the following claims.

1. A system for providing content to an output device comprising:
a computer readable medium;
a set of content in communications with said computer readable medium containing content for at least one bandwidth;
a set of computer readable instructions embodied in said computer readable medium for receiving a content request from said output device, generating at least one detection packet for transmission to said output device, receiving at least one detection packet return from said output device, determining the bandwidth of said output device according to said at least one detection packet and said at least one detection packet return, retrieving content from said set of content according to the bandwidth of said output device for transmission to said output device, so that said output device can receive and display content compatible with the bandwidth of said output device.

2. The system of claim 1 wherein said computer readable instructions include instructions for formatting said content according to the bandwidth of said output device.

3. The system of claim 1 wherein said set of content contains a plurality of content versions associated with predetermined bandwidths.

4. The system of claim 1 wherein:
said set of content contains content for at least one output device;
said content request includes a device ID; and,
said set of computer readable instructions includes instructions for retrieving content from said set of content according to said bandwidth of said output device and said device ID.

5. The system of claim 1 wherein:
said content request includes location information representing the geographic location of said output device; and,
said computer readable instructions include instructions for retrieving content from said set of content according to said location information.

6. The system of claim 5 wherein said computer readable instructions include instructions for translating said content according to said location information.

7. The system of claim 1 including:
a plurality of sets of content;
said content request includes content set information; and,
said computer readable instructions include instructions for retrieving content from at least one set of content according to said content set information.

8. The system of claim 1 including:
a computer readable buffer in communications with said computer readable medium; and,
said computer readable instructions include instructions for storing said retrieved content in said computer readable buffer, regulating transmission of said content to said output device according to said bandwidth of said output device so that content is provided to said output device in a controlled manner.

9. A system for providing content to an output device comprising:
a computer readable medium;
a set of content in communications with said computer readable medium;
a set of computer readable instructions embodied in said computer readable medium for receiving a content request from said output device, generating at least one detection packet for transmission to said output device, receiving at least one detection packet return from said output device, determining the bandwidth of said output device according to said at least one detection packet and said at least one detection packet return, retrieving content from said set of content according to said content request, formatting said content according to said bandwidth of said output device so that content can be transmitted to said output device and displayed that is compatible with the bandwidth of said output device.

10. The system of claim 9 wherein:
said set of content contains content for at least one output device;
said content request includes a device ID; and,
said set of computer readable instructions includes instructions for retrieving content from said set of content according to said bandwidth of said output device and said device ID.

11. The system of claim 9 wherein:
said content request includes location information representing the geographic location of said output device; and,
said computer readable instructions include instructions for retrieving content from said set of content according to said location information.

12. The system of claim 11 wherein said computer readable instructions include instructions for translating said content according to said location information.

13. The system of claim 9 including:
a plurality of sets of content;
said content request includes content set information; and,
said computer readable instructions include instructions for retrieving content from at least one set of content according to said content set information.

14. The system of claim 9 including:
a computer readable buffer in communications with said computer readable medium; and,
said computer readable instructions include instructions for storing said retrieved content in said computer readable buffer, regulating transmission of said content to said output device according to said bandwidth of said output device so that content is provided to said output device in a controlled manner.

15. A method for providing content to an output device comprising the steps of:
receiving a content request from said output device;
determining the bandwidth of said output device according to a detection packet and a detection packet return; and,
providing content to said output device according to the bandwidth of said output device.

16. The method of claim 15 including the step of formatting said content according to the bandwidth of said output device.

17. The method of claim 15 including the steps of:
receiving location information representing the location of said output device; and,
providing content to said output device according to said location information.

18. The method of claim 17 including the step of translating said content according to said location information.

19. The method of claim 15 including the steps of:
storing said retrieved content in said computer readable buffer; and,
regulating transmission of -said content to said output device according to said bandwidth of said output device so that content is provided to said output device in a controlled manner.

20. A system for providing content to output devices comprising:
a computer readable medium;
a set of content in communication with said computer readable medium and associated with device IDs having content for at least one device ID, said device ID representing bandwidth capacity for at least one output device;
a set of computer readable instructions for receiving a content request having device ID information representing bandwidth capabilities of said output device, determining if said received device ID is associated with content in said set of content, retrieving content according to said device ID from said set of content if said received device ID is associated with content, generating at least one detection packet for transmission to said output device if said received device ID is not associated with content, receiving at least one detection packet return according to said transmitted detection packet, determining the bandwidth of said output device according to said detection packet and said detection packet return, retrieving content from said set of content according to said bandwidth, and transmitting said content to said output device.

21. The system of claim 20 wherein said computer readable instructions include instructions for formatting said content according to said device ID.

22. The system of claim 20 wherein said computer readable instructions include instructions for formatting said content according to said bandwidth of said output device.

23. The system of claim 20 wherein:
said content request includes location information representing the geographic location of said output device; and,
said computer readable instructions include instructions for retrieving content from said set of content according to said location information.

24. The system of claim 23 wherein said computer readable instructions include instructions for translating said content according to said location information.

25. The system of claim 20 including:
a plurality of sets of content;
set content request includes content set information; and,
said computer readable instructions include instructions for retrieving content from at least one set of content according to said content set information.

26. The system of claim 20 including:
a computer readable buffer in communications with said computer readable medium; and,
said computer readable instructions include instructions for storing said retrieved content in said computer readable buffer, regulating transmission of said content to said output device according to said bandwidth of said output device so that content is provided to said output device in a controlled manner.
